(19) United States
(12) Patent Application Publication
(10) Pub. No.: US 2026/0316620 A1
(43) Pub. Date: Oct. 15, 2026

(54) CHARGING STATION OCCUPANCY PREDICTION MODEL

(71) Applicant: GM Global Technology Operations LLC, Detroit, MI (US)

(72) Inventors: Ariel Telpaz, Givat Haim Meuhad (IL); Ron Hecht, Raanana (IL); Gershon Celniker, Netanya (IL); Jeremie Benichou, Binyamina (IL); Eyal Sandler, Kadima (IL); Ravid Erez, West Bloomfield, MI (US)

(73) Assignee: GM Global Technology Operations LLC, Detroit, MI (US)

(21) Appl. No.: 19/175,767

(22) Filed: Apr. 10, 2025

(51) Int. Cl. B60L 53/67; B60L 53/66

(52) U.S. Cl. CPC B60L 53/67; B60L 53/66; B60L 2240/62; B60L 2240/72; B60L 2250/16

(57) ABSTRACT

A method of predicting future charging station occupancy includes receiving a usage history of a plurality of chargers, the usage history including respective charger properties for each charger of the plurality of chargers, and generating a usage history schedule by dividing the usage history into a plurality of time windows. The method also includes generating, as output from an encoder of an occupancy prediction model configured to receive the usage history schedule, a first higher order feature representation of the usage history schedule, generating, as output from an attention layer of the occupancy prediction model configured to receive the first higher order feature representation of the usage history generated by the encoder, attention scores of the encoder, and generating, as output from a decoder of the occupancy prediction model configured to receive the attention scores of the encoder, a time-distributed output of possible future charger occupancies.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a charging station occupancy prediction model. Electric vehicle (EV) drivers currently rely on a variety of methods to identify available charging stations when planning a road trip. These methods often include using mobile applications, in-car navigation systems, and online maps that provide real-time information about the location and availability of charging stations. These tools typically display the number of available chargers at a given station, the type of connectors available, and sometimes even the charging speed. Drivers can use this information to plan their routes and ensure they have access to necessary charging infrastructure along the way.

Notably, these systems are primarily designed to provide information about the current status of charging stations for drivers making immediate or near-term trips. While real-time data is valuable, availability of charging stations can fluctuate significantly due to various factors such as peak travel times, local events, and the overall increase in EV adoption. As a result, providing a predictive system that can forecast the future availability of charging stations may allow EV drivers planning future road trips to make more informed decisions and better plan their routes to ensure a seamless and efficient travel experience.

### SUMMARY

One aspect of the disclosure provides a computer-implemented method for a charging station occupancy prediction model that when executed on data processing hardware causes the data processing hardware to perform operations that include receiving a usage history of a plurality of chargers, the usage history including respective charger properties for each charger of the plurality of chargers, generating a usage history schedule by dividing the usage history into a plurality of time windows, and generating, as output from an encoder of an occupancy prediction model configured to receive the usage history schedule, a first higher order feature representation of the usage history schedule. The operations also include generating, as output from an attention layer of the occupancy prediction model configured to receive the first higher order feature representation of the usage history generated by the encoder, attention scores of the encoder, and generating, as output from a decoder of the occupancy prediction model configured to receive the attention scores of the encoder, a time-distributed output of possible future charger occupancies.

Implementations of the disclosure may include one or more of the following optional features. In some implementations, the operations further include generating a predicted future occupancy of the plurality of chargers based on the time-distributed output of possible charger occupancies and storing the predicted future occupancy in a data store. In these implementations, the operations may further include receiving a travel request from a user of a vehicle, the travel request requesting information on one or more charging stations located along a route of the travel request, querying a most recent predicted future occupancy of the plurality of chargers to identify relevant chargers of the plurality of chargers that correspond to the one or more charging stations, and presenting a predicted proportion of available chargers for each of the one or more charging stations. Here, presenting the predicted proportion of available chargers for each of the one or more charging stations may include identifying, for each charging station of the one or more charging stations, the relevant chargers associated with the charging station, and aggregating the respective predicted future occupancy the relevant chargers associated with the charging station. Additionally or alternatively, presenting the predicted proportion of available chargers for each of the one or more charging stations includes, displaying, on a screen in communication with the data processing hardware, the predicted proportion of available chargers for each of the one or more charging stations.

In some examples, the encoder includes a plurality of long short-term memory (LSTM) layers. In some implementations, the decoder includes a plurality of LSTM layers. In some examples, each time window of the plurality of time windows is four (4) hours. In some implementations, the charger properties include a respective charger state and corresponding temporal data associated with the charger state. In some examples, the operations further include executing the occupancy prediction model to generate a most recent time-distributed output of possible future charger occupancies every N hours.

Another aspect of the disclosure provides a system for a charging station occupancy prediction model that includes data processing hardware and memory hardware in communication with the data processing hardware. The memory hardware stores instructions that when executed by the data processing hardware cause the data processing hardware to perform operations that include receiving a usage history of a plurality of chargers, the usage history including respective charger properties for each charger of the plurality of chargers, generating a usage history schedule by dividing the usage history into a plurality of time windows, and generating, as output from an encoder of an occupancy prediction model configured to receive the usage history schedule, a first higher order feature representation of the usage history schedule. The operations also include generating, as output from an attention layer of the occupancy prediction model configured to receive the first higher order feature representation of the usage history generated by the encoder, attention scores of the encoder, and generating, as output from a decoder of the occupancy prediction model configured to receive the attention scores of the encoder, a time-distributed output of possible future charger occupancies.

This aspect may include one or more of the following optional features. In some implementations, the operations further include generating a predicted future occupancy of the plurality of chargers based on the time-distributed output of possible charger occupancies and storing the predicted future occupancy in a data store. In these implementations, the operations may further include receiving a travel request from a user of a vehicle, the travel request requesting information on one or more charging stations located along a route of the travel request, querying a most recent predicted future occupancy of the plurality of chargers to identify relevant chargers of the plurality of chargers that correspond to the one or more charging stations, and presenting a predicted proportion of available chargers for each of the one or more charging stations. Here, presenting the predicted proportion of available chargers for each of the one or more charging stations may include identifying, for each charging station of the one or more charging stations, the relevant chargers associated with the charging station, and aggregating the respective predicted future occupancy the relevant chargers associated with the charging station. Additionally or alternatively, presenting the predicted proportion of available chargers for each of the one or more charging stations includes, displaying, on a screen in communication with the data processing hardware, the predicted proportion of available chargers for each of the one or more charging stations.

In some examples, the encoder includes a plurality of LSTM layers. In some implementations, the decoder includes a plurality of LSTM layers. In some examples, the charger properties include a respective charger state and corresponding temporal data associated with the charger state. In some implementations, the operations further include executing the occupancy prediction model to generate a most recent time-distributed output of possible future charger occupancies every N hours.

Another aspect of the disclosure provides a computer-implemented method for predicting charging station occupancies that when executed on data processing hardware causes the data processing hardware to perform operations that include receiving a travel request from a user of a vehicle, the travel request requesting information on one or more charging stations located along a route of the travel request, and querying a predicted future occupancy data store to identify relevant chargers of a plurality of chargers that correspond to the one or more charging stations. The operations also include presenting a predicted proportion of available chargers of the identified relevant chargers for each of the one or more charging stations.

This aspect may include one or more of the following optional features. In some implementations, the predicted future occupancy data store includes a predicted future occupancy of the plurality of chargers generated by an occupancy prediction model configured to receive, as input, a usage history of a plurality of chargers and generate, as output, a time-distributed output of possible future charger occupancies.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is an example system for a charging station occupancy prediction model.

FIG. 2 is a schematic view of example components of the system of FIG. 1.

FIG. 3 is a schematic view of example components of an occupancy prediction model of the system of FIG. 1.

FIG. 4 is a schematic view of a graphical user interface of the system of FIG. 1.

FIG. 5 is a flowchart of an example arrangement of operations for a charging station occupancy prediction model.

FIG. 6 is a flowchart of an example arrangement of operations for a charging station occupancy prediction model.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

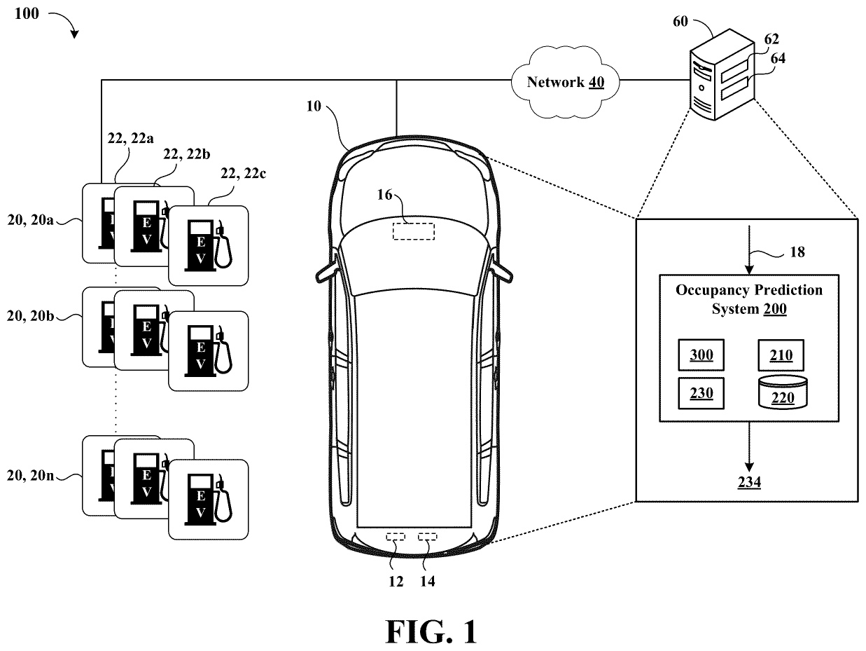

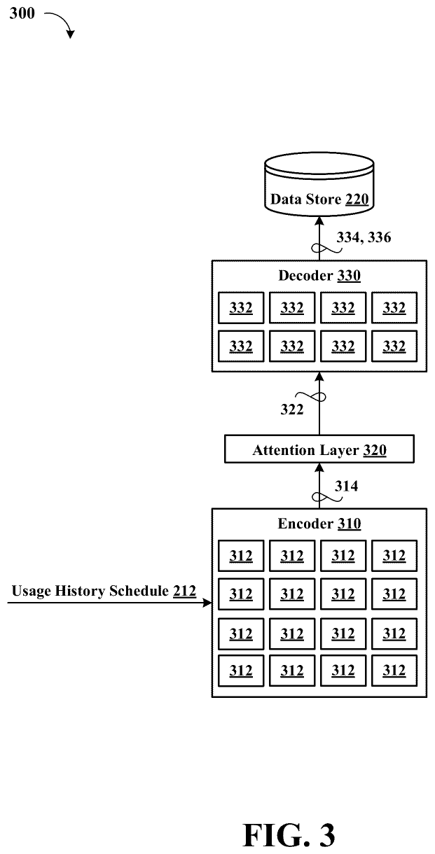

Referring to FIG. 1, in some implementations, a system 100 includes a vehicle 10 in communication with a remote system 60 via a network 40. As shown, the network 40 may further connect a plurality of charging stations 20, 20a-n (also referred to as electric vehicle (EV) charging stations 20) each including one or more chargers 22, 22a-n with the remote system 60 and/or the vehicle 10. The vehicle 10 and/or the remote system 60 include an occupancy prediction system 200 configured to assist in identifying charging locations along a planned route that a driver may use to recharge a battery of the vehicle 10 while planning a future road trip. Briefly, and as described in greater detail below, the occupancy prediction system 200 receives a travel request 18 from a user of the vehicle 10, the travel request 18 requesting information on one or more charging stations 20, 20a-n, and after querying a predicted future occupancy data store 220 to identify relevant chargers 22, 22a-n that correspond to the one or more charging stations 20, presents a predicted portion 234 of available chargers 22 of the identified relevant chargers 22. As used herein, the travel request 18 refers to a road trip planned several days in advance, where the real time availability of a particular charger 22 or charging station 20 may have limited relevance for the user of the vehicle 10. As such, the occupancy prediction system 200 executes an occupancy prediction model 300 (FIG. 3) configured to forecast an occupancy of available chargers 22 in one or more charging stations 20 based on historical usage 202 of the chargers 22. Thereafter, users planning road trips can leverage these forecasts (i.e., a predicted future occupancy 336) to make better informed decisions when planning driving routes to limit disruptions.

In the example shown, the occupancy prediction system 200 is implemented within the vehicle 10. However, the occupancy prediction system 200 may be implemented in any other propulsion system, such as, without limitation, motorcycles, trucks, off-road vehicles, farm equipment, trains, aircraft, and the like. The vehicle 10 includes data processing hardware 12 and memory hardware 14 storing instructions that when executed on the data processing hardware 12 cause the data processing hardware 12 to perform operations. Additionally, while the occupancy prediction system 200 is described as being implemented by the data processing hardware 12 and memory hardware 14 of the vehicle 10, its operations can be implemented on other computing devices (e.g., computing devices in communication with the vehicle 10), such as, without limitation, a smart phone, tablet, smart display, desktop/laptop, smart watch, smart appliance, or smart glasses/headset. As shown, the vehicle 10 further includes a graphical user interface 16 through which the user of the vehicle 10 uses to interact with the occupancy prediction system 200.

The network 40 may include a wireless local area network (WLAN) that facilitates communication and interoperability between the vehicle 10, the remote system 60, and the plurality of charging stations 20. Thus, the network 40 can include Wireless Fidelity (WiFi®) (e.g., IEEE 802.11), Low-Rate Wireless Personal Area Networks (e.g., IEEE 802.15.4), worldwide interoperability for microwave access (WiMAX), 3G, 4G, Long Term Evolution (LTE), 5G, digital subscriber line (DSL), Bluetooth, Near Field Communication (NFC), or any other wireless standards, or Ethernet (e.g., IEEE 802.3). The system 100 may additionally include one or more access points (AP) (not shown) configured to facilitate wireless communication between the vehicle 10, the remote system 60, and the charging stations 20.

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the occupancy prediction system 200 is shared across the vehicle 10 and the remote system 60. As described in greater detail with respect to FIGS. 1-4, the occupancy prediction system 200 executing on the vehicle 10 and/or the remote system 60 executes the occupancy prediction model 300 and the response generator 230. As will become apparent, the occupancy prediction model 300 and the response generator 230 cooperate to leverage usage history 202 of individual chargers 22 in a network of individual chargers 22 to generate a predicted future occupancy 336 of the chargers 22, and use this predicted future occupancy 336 to provide a user planning future travel with a proportion of predicted available chargers 22 for a driving route of the future travel.

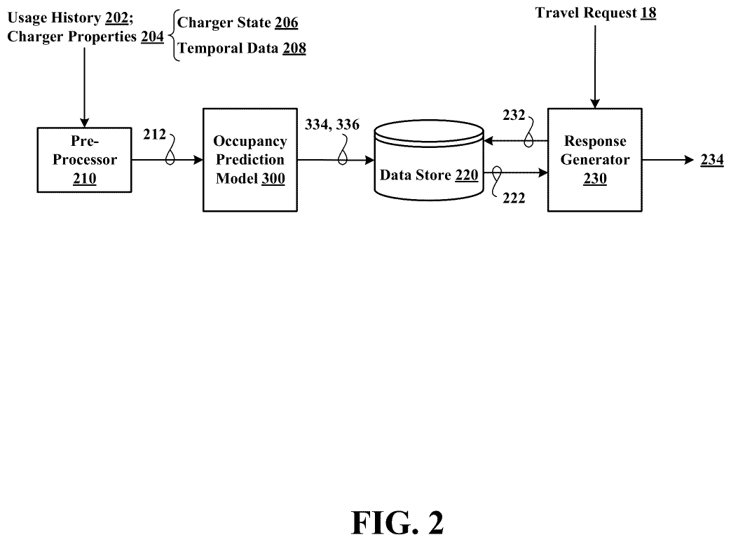

Referring to FIGS. 1 and 2, the occupancy prediction system 200 includes a pre-processor 210, the occupancy prediction model 300, and a response generator 230. The occupancy prediction system 200 further has access to a predicted future occupancy data store 220 (also referred to as a data store 220) stored on the memory hardware 14, 64 of the system 100. The pre-processor 210 is configured to receive the usage history 202 of a plurality of chargers 22 as input, and process the usage history 202 to generate, as output a usage history schedule 212 of the chargers 22. Here, the usage history 202 may include respective charger properties 204 for each charger 22 of the plurality of chargers. For instance, the respective charger properties 204 for each charger 22 may include a charger state 206 (i.e., in use or available) and the corresponding temporal data 208 (i.e., time and date) associated with the charger state 206. The pre-processor 210 may divide the input usage history 202 into a plurality of time windows based the corresponding temporal data 208 for each charger 22. For instance, the pre-processor may divide the usage history 202 into a usage schedule where each window is four (4) hours. In this example, for every twenty-four (24) hours in a day, there are six (6) windows, each window being four (4) hours from 0:00-4:00, 4:00-8:00, 8:00-12:00, 12:00-16:00, 16:00-20:00, and 20:00-24:00. In other words, the usage history schedule 212 may include the usage history 202 split into forty-two (42) intervals per week, or 336 intervals (i.e., the past two months of charger properties 204 for the chargers 22). In some instances the usage history schedule 212 includes a log entry of each reported charger state 206 for each charger 22 recorded in a window based on its corresponding temporal data 208.

With reference to FIGS. 2 and 3, the occupancy prediction model 300 predicts the availability of chargers 22 over an upcoming week based on the usage history schedule 212 over the previous two (2) months (i.e., 336 window intervals). To accomplish this, the occupancy prediction model 300 is configured to receive the usage history schedule 212 of the chargers 22 as input and generate, as output, a time-distributed output 334 of possible future charger occupancies corresponding to a predicted future occupancy 336 of the chargers 22 over the future time interval (i.e., the next week). With particular reference to FIG. 3, the occupancy prediction model 300 has a sequence-to-sequence architecture that includes an encoder 310, an attention layer 320, and a decoder 330. As shown, the attention layer 320 is disposed between the encoder 310 and the decoder 330 to communicate the outputs of the encoder 310 to the decoder 330. In some instances, the attention layer 320 learns patterns of the encoder 310 as it communicates the output from the encoder 310 to the decoder 330. In other words, the attention layer 320 may attend to the higher level features output by the encoder 310 to learn an alignment between the input usage history schedule 212 and predicted occupancies.

With particular reference to FIG. 3, each of the encoder 310 and the decoder 330 may be constructed with a long short term memory (LSTM) structure. However, it should be understood that one or more of the encoder 310 and the decoder 330 may be constructed with conformer layers (e.g., a conformer-transducer) or transformer layers. In other words, the encoder 310 and the decoder 330 may have different architectures or similar architectures. In some examples, the encoder 310 includes sixteen (16) unidirectional LSTM layers 312, where each LSTM layer 312 of the encoder 310 includes 64 neurons (i.e., 64-dimensional). The decoder 330 may include eight (8) unidirectional LSTM layers 332, where each LSTM layer 332 of the decoder 330 may include 64 neurons (i.e., 64-dimensional). The occupancy prediction system 200 may periodically tune the hyperparameters of the occupancy prediction model 300 to optimize the model hyperparameters. Additionally or alternatively, the occupancy prediction system 200 may evaluate the occupancy prediction model 300 by checking the pairwise prediction accuracy of the occupancy prediction model 300 for whether a particular charging station 20 will be more occupied (i.e., more chargers 22 at the charging station 20) will be more occupied among 1,000 random pairs of charging stations 20 at random times.

As shown, the encoder 310 is configured to receive, as input, the usage history schedule 212 for the previous two months (i.e., 336 time windows) and generate, as output, a first higher order feature representation 314 of the usage history schedule 212. The attention layer 320 receives, as input, the first higher order feature representation 314 output by the encoder 310 and generates, as output, attention scores 322 of the encoder 320. The attention scores 322 may be used to focus the attention of the decoder 330 on the relevant portions of the first higher order feature representation 314 of the usage history schedule 212.

The decoder 330 receives, as input, the attention scores 322 from the encoder 310 generated by the attention layer 320 and generates, as output, a time-distributed output 334 of possible future charger occupancies of the chargers 22. Here, the time-distributed output 334 of possible future charger occupancies may be generated from a regression output that specifically predicts a value for each time window over the upcoming week (i.e., 42 time windows). In other words, the time-distributed output 334 of possible future charger occupancies may be structured as a dense layer with a single output for each time window of the future week. In some cases, the occupancy prediction model 300 further generates a predicted future occupancy 336 of each charger 22 of the plurality of chargers 22 based on the time-distributed output 334 of possible charger occupancies. Thereafter, the time-distributed output 334 of possible charger occupancies and the corresponding predicted future occupancy 336 are stored in the predicted future occupancy data store 220. In some implementations, the occupancy prediction model 300 executes every N hours (e.g., every 24 hours) to update the predicted future occupancy data store 220 with a most recent time-distributed output 334 of possible charger occupancies and corresponding most recent predicted future occupancy 336 for each of the chargers 22.

Referring again to FIG. 2, the most recent time-distributed output 334 and/or the most recent predicted future occupancy 336 may subsequently be used by a user of the vehicle 10 that queries the occupancy prediction system 200 to establish the optimal chargers 22 and/or charging stations 20 to stop at along a particular route. In particular, the response generator 230 of the occupancy prediction system 200 may receive, as input, a travel request 18 from a user of the vehicle 10. The travel request 18 may request information on one or more charging stations 20 located along a route of the travel request 18, where the information pertains to a future trip (i.e., a week in advance). Here, the response generator 230 may query the predicted future occupancy data store 220 to determine relevant chargers 22 along the route of the travel request 18. In this case, the response generator 230 may query the most recent predicted future occupancy 336 stored in the predicted future occupancy data store 220 to identify the relevant chargers 22 of a plurality of chargers 22 that correspond to one or more charging stations 20 along the route of the travel request 18. Thereafter, the response generator 230 may present a predicted proportion 234 of the available chargers 22 for each of the one or more charging stations 22 along the route.

Notably, the most recent time-distributed output 334 of possible charger occupancies and the corresponding most recent predicted future occupancy 336 are output for each individual charger 22. However, each charging station 20 along the route typically includes one or more chargers 22. As such, the response generator 230 may processes the predicted future occupancy 336 of each of the relevant chargers 22 for each of the one or more charging stations 20 along the route to aggregate the chargers 22 by charging station 20 and calculate the proportion of available chargers 22 for each future time window at the charging station 20. Here, the response generator 230 may identify, for each charging station 20 of the one or more charging stations 20 along the route of the travel request 18, the chargers 22 associated with the charging station 20, and aggregate the respective predicted future occupancies 336 associated with the relevant chargers 22 of the charging station 20.

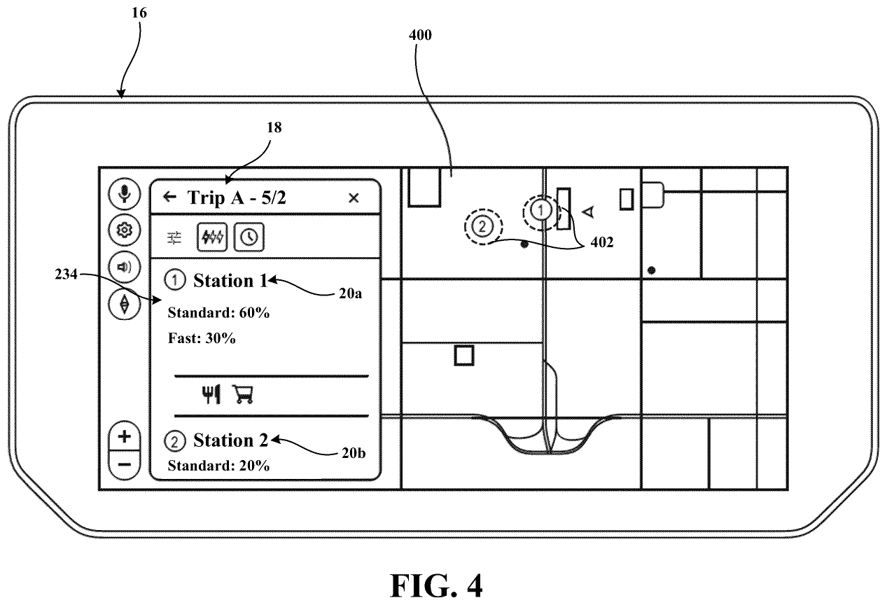

With particular reference to FIG. 4, the response generator 230 may display the predicted proportion 234 of the available chargers 22 for each of the one or more charging stations 20 along the route of the travel request 18 in a screen 400 of the graphical user interface 16 of the vehicle 10. The screen 400 of the graphical user interface 16 may be in communication (wired or wirelessly) with the data processing hardware 12, 62 of the system 100. As shown, the screen 400 shows a maps application including the travel request 18 and the corresponding charging stations 20a, 20b along a route of the travel request 18. The screen 400 further displays the predicted proportion 234 of the chargers 22 for each of the charging stations 20a, 20b. Additionally, the screen 400 may include visual cues (i.e., graphical elements) 402 highlighting the locations of the charging stations 20a, 20b along the route. Here, the user of the vehicle 10 that is planning the trip including the travel request 18 may plan to stop at a particular one of the charging stations 20a, 20b based on the forecast/predicted availability of chargers 22 at each of the charging stations 20a, 20b.

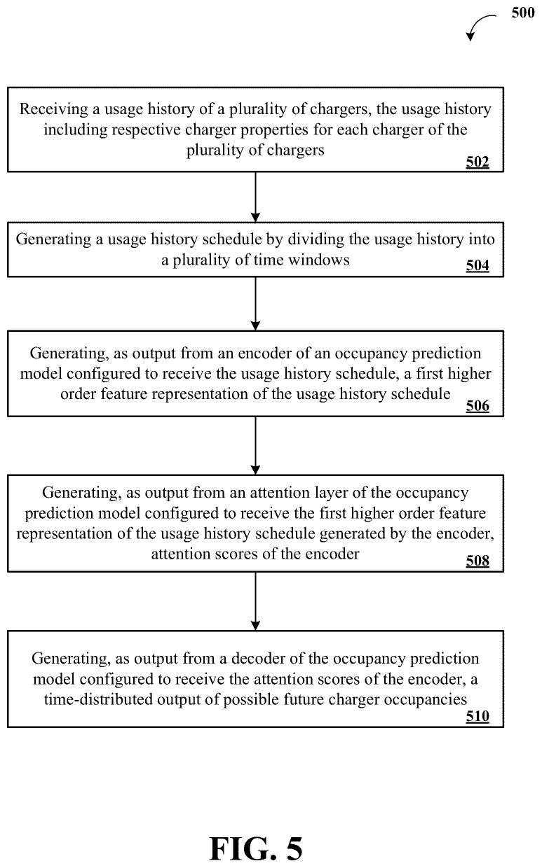

FIG. 5 includes a flowchart of an example arrangement of operations for a method 500 for a charging station occupancy prediction model. The method 500 may be described with reference to FIGS. 1-4. Data processing hardware (e.g., data processing hardware 12, 62 of FIG. 1) may execute instructions stored on memory hardware (e.g., memory hardware 14, 64 of FIG. 1) to perform the example arrangement of operations for the method 500.

At operation 502, the method 500 includes receiving a usage history 202 of a plurality of chargers 22, 22a-n, the usage history 202 including respective charger properties 24, 24a-n for each charger 22 of the plurality of chargers 22. At operation 504, the method 500 includes generating a usage history schedule 212 by dividing the usage history 202 into a plurality of time windows. The method 500 also includes, at operation 506, generating, as output from an encoder 310 of an occupancy prediction model 300 configured to receive the usage history schedule 212, a first higher order feature representation 314 of the usage history schedule 212.

At operation 508, the method 500 includes generating, as output from an attention layer 320 of the occupancy prediction model 300 configured to receive the first higher order feature representation 314 of the usage history schedule 212 generated by the encoder 310, attention scores 322 of the encoder 310. The method 500 also includes, at operation 510, generating, as output from a decoder 330 of the occupancy prediction model 300 configured to receive the attention scores 322 of the encoder 310, a time-distributed output 334 of possible future charger occupancies.

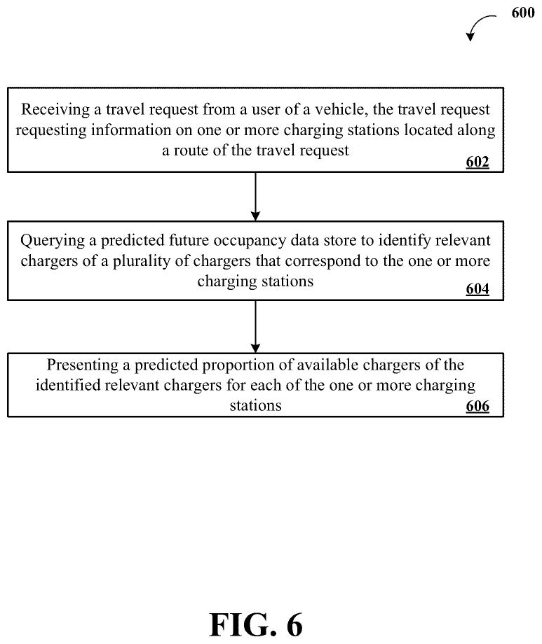

FIG. 6 includes a flowchart of an example arrangement of operations for a method 600 for predicting charging station occupancies. The method 600 may be described with reference to FIGS. 1-4. Data processing hardware (e.g., data processing hardware 12, 62 of FIG. 1) may execute instructions stored on memory hardware (e.g., memory hardware 14, 64 of FIG. 1) to perform the example arrangement of operations for the method 600.

At operation 602, the method 600 includes receiving a travel request 18 from a user of a vehicle 10. Here, the travel request 18 requests information on one or more charging stations 20, 20a-n located along a route of the travel request 18. The method 600 also includes, at operation 602, querying a predicted future occupancy data store 220 to identify relevant chargers 22 of a plurality of chargers 22 that correspond to the one or more charging stations 20. At operation 606, the method 600 further includes presenting a predicted proportion 234 of available chargers 22 of the identified relevant chargers 22 for each one of the one or more charging stations 20.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method executing on data processing hardware that causes the data processing hardware to perform operations comprising:
receiving a usage history of a plurality of chargers, the usage history including respective charger properties for each charger of the plurality of chargers;
generating a usage history schedule by dividing the usage history into a plurality of time windows;
generating, as output from an encoder of an occupancy prediction model configured to receive the usage history schedule, a first higher order feature representation of the usage history schedule;
generating, as output from an attention layer of the occupancy prediction model configured to receive the first higher order feature representation of the usage history schedule generated by the encoder, attention scores of the encoder; and
generating, as output from a decoder of the occupancy prediction model configured to receive the attention scores of the encoder, a time-distributed output of possible future charger occupancies.

2. The method of claim 1, wherein the operations further comprise:
generating a predicted future occupancy of the plurality of chargers based on the time-distributed output of possible charger occupancies; and
storing the predicted future occupancy in a data store.

3. The method of claim 2, wherein the operations further comprise:
receiving a travel request from a user of a vehicle, the travel request requesting information on one or more charging stations located along a route of the travel request;
querying a most recent predicted future occupancy of the plurality of chargers to identify relevant chargers of the plurality of chargers that correspond to the one or more charging stations; and
presenting a predicted proportion of available chargers for each of the one or more charging stations.

4. The method of claim 3, wherein presenting the predicted proportion of available chargers for each of the one or more charging stations comprises:
identifying, for each charging station of the one or more charging stations, the relevant chargers associated with the charging station; and
aggregating the respective predicted future occupancy the relevant chargers associated with the charging station.

5. The method of claim 3, wherein presenting the predicted proportion of available chargers for each of the one or more charging stations comprises, displaying, on a screen in communication with the data processing hardware, the predicted proportion of available chargers for each of the one or more charging stations.

6. The method of claim 1, wherein the encoder comprises a plurality of long short-term memory (LSTM) layers.

7. The method of claim 1, wherein the decoder comprises a plurality of LSTM layers.

8. The method of claim 1, wherein each time window of the plurality of time windows is four (4) hours.

9. The method of claim 1, wherein the charger properties comprise a respective charger state and corresponding temporal data associated with the charger state.

10. The method of claim 1, wherein the operations further comprise executing the occupancy prediction model to generate a most recent time-distributed output of possible future charger occupancies every N hours.

11. A system comprising:
data processing hardware; and
memory hardware in communication with the data processing hardware, the memory hardware storing instructions that when executed on the data processing hardware cause the data processing hardware to perform operations comprising:
receiving a usage history of a plurality of chargers, the usage history including respective charger properties for each charger of the plurality of chargers;
generating a usage history schedule by dividing the usage history into a plurality of time windows;
generating, as output from an encoder of an occupancy prediction model configured to receive the usage history schedule, a first higher order feature representation of the usage history schedule;
generating, as output from an attention layer of the occupancy prediction model configured to receive the first higher order feature representation of the usage history schedule generated by the encoder, attention scores of the encoder; and
generating, as output from a decoder of the occupancy prediction model configured to receive the attention scores of the encoder, a time-distributed output of possible future charger occupancies.

12. The system of claim 11, wherein the operations further comprise:
generating a predicted future occupancy of the plurality of chargers based on the time-distributed output of possible charger occupancies; and
storing the predicted future occupancy in a data store.

13. The system of claim 12, wherein the operations further comprise:
receiving a travel request from a user of a vehicle, the travel request requesting information on one or more charging stations located along a route of the travel request;
querying a most recent predicted future occupancy of the plurality of chargers to identify relevant chargers of the plurality of chargers that correspond to the one or more charging stations; and
presenting a predicted proportion of available chargers for each of the one or more charging stations.

14. The system of claim 13, wherein presenting the predicted proportion of available chargers for each of the one or more charging stations comprises:
identifying, for each charging station of the one or more charging stations, the relevant chargers associated with the charging station; and
aggregating the respective predicted future occupancy the relevant chargers associated with the charging station.

15. The system of claim 13, wherein presenting the predicted proportion of available chargers for each of the one or more charging stations comprises, displaying, on a screen in communication with the data processing hardware, the predicted proportion of available chargers for each of the one or more charging stations.

16. The system of claim 11, wherein the encoder comprises a plurality of long short-term memory (LSTM) layers.

17. The system of claim 11, wherein the decoder comprises a plurality of LSTM layers.

18. The system of claim 11, wherein the operations further comprise executing the occupancy prediction model to generate a most recent time-distributed output of possible future charger occupancies every N hours.

19. A computer-implemented method executing on data processing hardware that causes the data processing hardware to perform operations comprising:
receiving a travel request from a user of a vehicle, the travel request requesting information on one or more charging stations located along a route of the travel request;
querying a predicted future occupancy data store to identify relevant chargers of a plurality of chargers that correspond to the one or more charging stations; and
presenting a predicted proportion of available chargers of the identified relevant chargers for each of the one or more charging stations.

20. The method of claim 19, wherein the predicted future occupancy data store includes a predicted future occupancy of the plurality of chargers generated by an occupancy prediction model configured to receive, as input, a usage history of a plurality of chargers and generate, as output, a time-distributed output of possible future charger occupancies.
